(19) United States
(12) Patent Application Publication
(10) Pub. No.: US 2016/0114406 A1
(43) Pub. Date: Apr. 28, 2016

(54) TOOL CLAMPING DEVICE

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventor: XIAO-HONG ZENG, Jiashan (CN)

(21) Appl. No.: 14/614,634

(22) Filed: Feb. 5, 2015

(30) Foreign Application Priority Data
Oct. 22, 2014 (CN) 201410565499.0

(51) Int. Cl. B23B 31/20

(52) U.S. Cl. CPC B23B 31/20; B23B 2260/008

(57) ABSTRACT

A tool clamping device for holding a cutting tool, the tool clamping device includes a holder, a collet coupled to the holding cavity, and a lock nut. The holder defines a holding cavity. The lock nut includes a nut body engaged with the holder, a rotating member received in the nut body, and a plurality of rollers assembled to the rotating member. The collet is connected to the rotating member, and the nut body rotates relative to the rotating member by the plurality of rollers. The lock nut is configured to press the collet in the holding cavity, and the cutting tool is clamped by the collet.

### FIELD

The subject matter herein generally relates to a clamping device, and particularly to a clamping device for holding a cutting tool.

### BACKGROUND

A clamping device for holding a shank portion of a cutting tool includes a lock nut screwed onto a holder, the lock nut presses a tapered collet into a tapered hole of the holder. At this time, the diameter of the tapered collet is reduced, whereby the tapered collet holds the shank portion.

### BRIEF DESCRIPTION OF THE DRAWINGS

Implementations of the present technology will now be described, by way of example only, with reference to the attached figures.

FIG. 1 is an isometric view of an embodiment of a tool clamping device.

FIG. 2 is an exploded, isometric view of the tool clamping device of FIG. 1.

FIG. 3 is a cross-sectional view of the tool clamping device taken along line III-III of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a tool clamping device.

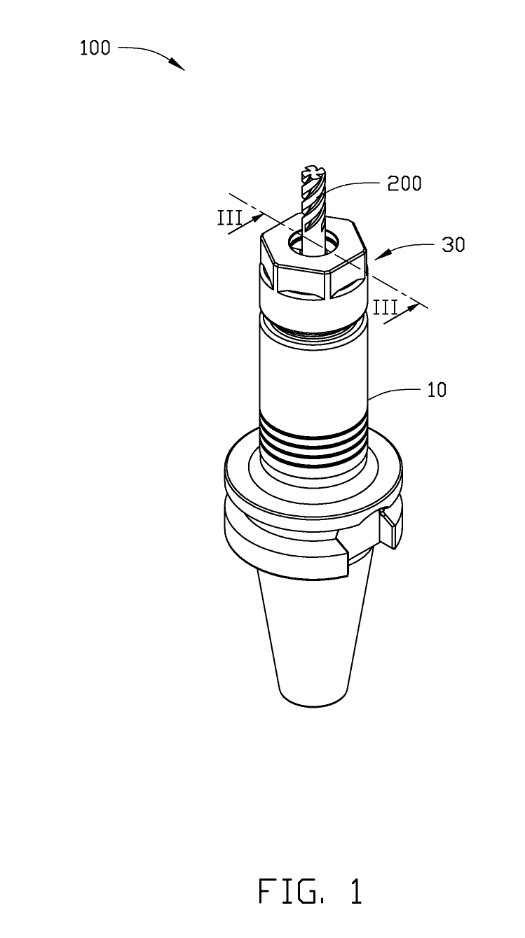

FIG. 1 illustrates an isometric view of an embodiment of a tool clamping device 100. The tool clamping device 100 can include a holder 10 and a lock nut 30, and can be configured to hold a cutting tool 200.

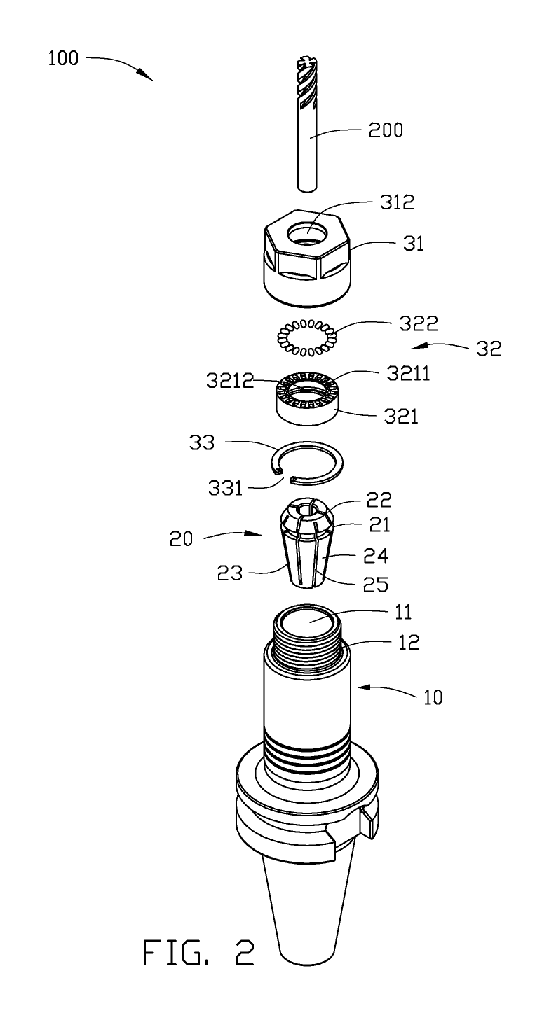

FIG. 2 illustrates an exploded, isometric view of the tool clamping device 100. The holder 10 can include a holding cavity 11 defined therein and a first threaded portion 12 formed on an outer surface of the holding cavity 11. The holding cavity 11 can be substantially tapered, and an inner diameter of the holding cavity 11 can decrease along a direction away from the lock nut 30.

The tool clamping device 100 can further include a collet 20. The collet 20 can be made of an elastic material, and include a circular groove 21, a head portion 22, and a main body 23. The head portion 22 can be separated from the main body 23 by the circular groove 21. The head portion 22 can be substantially tapered, and an outer diameter can decrease along a direction away from the main body 23. The head portion 22 can be engaged with the lock nut 30, to clamp the cutting tool 200. The main body 23 can be substantially tapered, and a diameter of the main body 23 can decrease along a direction away from the head portion 22. The main body 23 can be engaged to the holding cavity 11, and configured for insertion of the cutting tool 200.

The main body 23 of the collet 20 can include a plurality of web plates 24 and a plurality of slots 25, and each slot 25 can be sandwiched by two adjacent web plates 24. The plurality of slots 25 can be spaced from each other and evenly arranged in the circumferential direction of the collet 20. An inner surface of the holding cavity 11 can press against the plurality of web plates 24, and the collet 20 with the slots 25 expanding or contracting by means of elastic deformation, thereby releasing or holding the cutting tool 200.

The lock nut 30 can include a hollow nut body 31, a rotating member 32 assembled to the nut body 31 and a resisting member 33. The nut body 31 can include an assembly hole 312, a diameter of the assembly hole 312 can be equal to that of the cutting tool 200, thus, the cutting tool 200 can pass precisely through the assembly hole 312, and can be clamped by the collet 20.

The rotating member 32 can include a rotating body 321 and a plurality of rollers 322 in working cooperation with the rotating member 32, and the plurality of rollers 322 can be assembled to the rotating body 321. The rotating body 321 can include a plurality of recesses 3211 and a through hole 3212. The plurality of recesses 3211 can be spaced from each other and evenly defined on a surface of the rotating body 321 toward the assembly hole 312. Each recess 3211 can be substantially bar-shaped. The through hole 3212 can be coupled to the head portion 22 of the collet 20, and configured to clamp the cutting tool 200. An inner diameter of the through hole 3212 can increase along a direction away from the rollers 322.

The roller 322 can be substantially cylindrical, and a size of the roller 322 can be equaled to that of the recess 3211. The roller 322 can be received in the recess 3211, and rotated relative to the recess 3211. In at least one embodiment, the roller 322 can be replaced by a ball bearing, and the corresponding recess 3211 can be shaped as a hemisphere, thereby the ball bearing can rotate relative the hemispherical recess.

The resisting member 33 can be substantially annular, and made of an elastic material. An opening 331 can be defined on the resisting member 33, and the resisting member 33 with the opening 331 can expand or contract by means of elastic deformation.

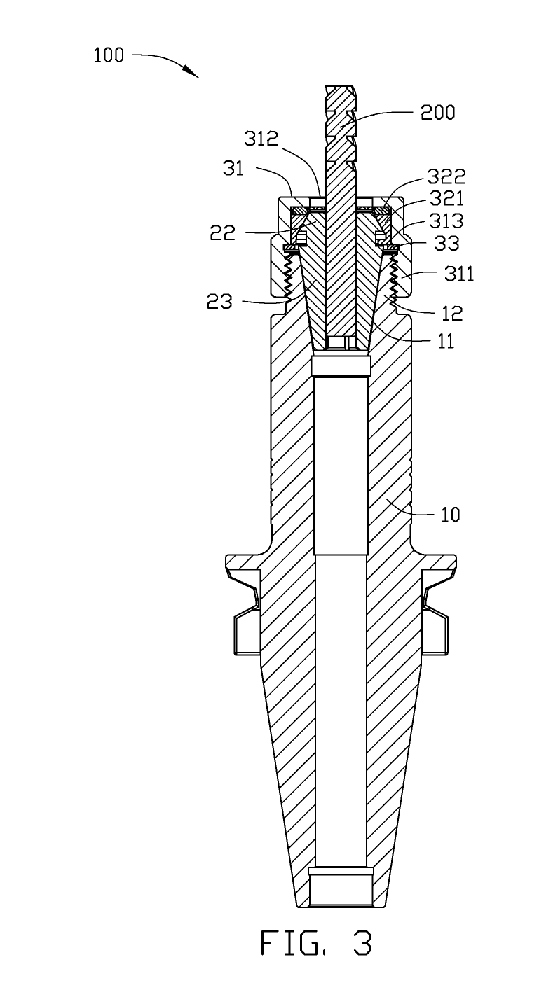

FIG. 3 illustrates a cross-sectional view of the tool clamping device 100. The nut body 31 can further include a second threaded portion 311 engaged with the first threaded portion 12, and a receiving cavity 313 sandwiched between the second threaded portion 311 and the assembly hole 312. The second threaded portion 311 can be defined on an inner surface of the nut body 31, and a diameter of the assembly hole 312 can be less than that of the second threaded portion 311.

The rotating body 321 can be substantially annular, and an outer diameter of the rotating body 321 can be less than that of the receiving cavity 313. Thereby the rotating body 321 can be rotated relative to the receiving cavity 313.

The resisting member 33 can be assembled to the receiving cavity 313, and configured to limit the rotating member 32 (shown in FIG. 2). The resisting member 33 can elastically press against an inner surface of the receiving cavity 313, which can prevent the rotating member 32 from running off the receiving cavity 313. In other embodiments, a circular groove (not shown) can be defined on the inner surface of the receiving cavity 313, the resisting member 33 can be coupled to the circular groove, to enhance the connection strength between the resisting member 33 and the nut body 31.

In assembling, a plurality of rollers 322 can be assembled to the plurality of recesses 3211. Then the rotating member 32 with a plurality of rollers 322 can be received in the receiving cavity 313, and the resisting member 33 can be assembled in the receiving cavity 313, to prevent the rotating member 32 from running off the receiving cavity 313. The head portion 22 of the collet 20 can be coupled to the through hole 3212. Then the cutting tool 200 can pass through the assembly hole 312, and can be clamped by the collet 20. At last, the first threaded portion 12 can be engaged with the second threaded portion 311, and to fasten the cutting tool 200 in the holder 10.

The tool clamping device 100 can have a rotating member 32 assembled to the nut body 31, and a plurality of rollers 322 can be sandwiched between the rotating member 32 and the nut body 31. So the rotating member 32 can be freely rotated relative to the nut body 31. Torsion of the nut body 31 cannot be transferred to the collet 20 by rotating the nut body 31, and the collet 20 cannot be easily deformed. Therefore, a gripping force of the tool clamping device 100 can be increased and the tool clamping device 100 can hold the cutting tool 200 stably.

The embodiments shown and described above are only examples. Many details are often found in the art such as the other features of a tool clamping device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A tool clamping device for holding a cutting tool, the tool clamping device comprising:
a holder comprising a holding cavity defined therein;
a collet coupled to the holding cavity; and
a lock nut comprising:
a nut body engaged with the holder;
a rotating member received in the nut body, connected to the collet, and rotatable relative to the nut body; and
a plurality of rollers in working cooperation with the rotating member; and
wherein the lock nut is configured to press the collet into the holding cavity, and the cutting tool is clamped by the collet.

2. The tool clamping device as claimed in claim 1, wherein the collet comprises a circular groove, a head portion engaged with the rotating member, and a main body coupled to the holding cavity of the holder; and the head portion is separated from the main body by the circular groove.

3. The tool clamping device as claimed in claim 2, wherein the main body comprises a plurality of web plates and a plurality of slots, the plurality of slots are spaced from each other and evenly arranged in the circumferential direction of the collet.

4. The tool clamping device as claimed in claim 3, wherein an inner surface of the holding cavity presses against the plurality of web plates, and the collet with the slots expands or contracts by means of elastic deformation, thereby releasing or holding the cutting tool.

5. The tool clamping device as claimed in claim 3, wherein the rotating member comprises a rotating body, and a plurality of rollers are assembled to the rotating body.

6. The tool clamping device as claimed in claim 5, wherein the rotating body comprises a plurality of recesses and a through hole, the through hole is coupled to the head portion of the collet, and configured to clamp the cutting tool; and an inner diameter of the through hole increases along a direction away from the rollers.

7. The tool clamping device as claimed in claim 1, wherein a first threaded portion is formed on an outer surface of the holding cavity, the nut body comprises a second threaded portion coupled to the first threaded portion.

8. The tool clamping device as claimed in claim 7, wherein the nut body further comprises an assembly hole, and a receiving cavity sandwiched between the second threaded portion and the assembly hole.

9. The tool clamping device as claimed in claim 8, wherein the cutting tool passes through the assembly hole, and clamped by the collet; and a diameter of the assembly hole is less than that of the second threaded portion.

10. The tool clamping device as claimed in claim 8, wherein an outer diameter of the rotating member is less than that of the receiving cavity, the rotating member is received in the receiving cavity, and rotated relative to the receiving cavity.

11. The tool clamping device as claimed in claim 8, wherein the lock nut further comprises a resisting member received in the receiving cavity, and the resisting member elastically presses against an inner surface of the receiving cavity, to prevent the rotating member from running off the receiving cavity.

12. The tool clamping device as claimed in claim 11, wherein an opening is defined on the resisting member, and the resisting member with the opening expands or contracts by means of elastic deformation.
